(19) United States
(12) Patent Application Publication
(10) Pub. No.: US 2023/0213341 A1
(43) Pub. Date: Jul. 6, 2023

(54) REMOVABLE ODOMETER FOR A NON-ODOMETER EQUIPPED VEHICLE

(71) Applicant: Dynapar Corporation, Elizabethtown, NC (US)

(72) Inventor: Kenneth L. DICKINSON, Columbus, OH (US)

(21) Appl. No.: 18/150,497

(22) Filed: Jan. 5, 2023

Related U.S. Application Data
(60) Provisional application No. 63/296,982, filed on Jan. 6, 2022.

(51) Int. Cl. G01C 21/16; G01S 13/60; B60R 11/00

(52) U.S. Cl. CPC G01C 21/1652; B60R 11/00; G01S 13/60; B60R 2011/007; B60R 2011/0071; G01S 2013/9327

(57) ABSTRACT

An odometer comprises a housing having a vehicle mounting device attached thereto. In an embodiment, the vehicle mounting device configured to be connectable to and removable from the non-odometer equipped vehicle. The housing further comprises a doppler radar module disposed in the housing. A processor is disposed in the housing and operatively connected to the doppler radar module and memory. In turn, the memory comprises executable instructions that, when executed by the processor, cause the processor to receive, from the doppler radar module, velocity-indicative data relative to a surface traveled by the non-odometer equipped vehicle. Thereafter, the processor operates to determine a distance traveled by the non-odometer equipped vehicle based on the velocity-indicative data.

### FIELD

The present disclosure concerns odometers and, in particular, a removable odometer for use in non-odometer equipped vehicles.

### BACKGROUND

As known in the art, odometers are devices used to determine distances traveled by vehicles. Most typically, vehicles, such as automobiles, trucks, etc., come equipped with such odometers. However, there is a wide variety of non-odometer equipped vehicles in use where it is nevertheless desirable to obtain data concerning distances traveled. Such vehicles are typically, but not always, unpowered (i.e., incapable of moving on their own) and configured to be towed by another, powered vehicle. Non-exhaustive examples of such vehicles include semi-trailers, certain agricultural equipment, etc.

Examples of prior art solutions for providing odometer capability to non-odometer equipped vehicles are illustrated in FIG. 1. In particular, FIG. 1 illustrates an example in which the non-odometer equipped vehicle is a semi-trailer 102 that, as known in the art, may be connected to a tractor 104 capable of towing the semi-trailer 102. Two common odometer solutions for use in such scenarios include a hubodometer 106 and a global positioning satellite (GPS) tracker 108.

As known in the art, a hubometer 106 mounts to a center hub of a vehicle wheel or tire. As the wheel rotates, a portion of the hubodometer 106 rotates in synchrony with the wheel and a number of rotations are counted by a mechanical or electronic mechanism that is used to calculate the distance traveled. While the hubometer 106 does provide useful odometer data, it does suffer from several disadvantages. For example, in the case of conventional inflated tires, the calculation of the distance traveled can be inaccurate due to variances in actual tire diameter, inflation pressure, load placed on the tires, etc. Furthermore, the hubodometer 106 is obviously restricted to placement only the center of a wheel. Mounting a hubometer requires, in some cases, a vehicle be taken out of service, jacked up, and tires removed, which can often incur a sizable cost investment of skilled mechanics.

On the other hand, the GPS tracker 108 utilizes signals from satellites and is generally battery powered. By determining locations of the GPS tracker 108 during travel, distances between such locations can be determined and cumulated. Such performance requires the GPS tracker 108 to be in continuous sight of the satellites in order to receive the necessary timing signals. However, in practice, such signals can be lost, for example, due to severe weather (e.g., heavy snow), signal obstruction (e.g., mountains or large buildings) or multipath signal interference (e.g., in urban environments with many electromagnetically reflective surfaces). In addition, power consumption limitations tend to limit GPS trackers to only perform location measurements periodically and not continuously. As a result, intervening speed peaks, short detours, circular routes or reversed travel are often missed or not measured correctly.

Thus, solutions that overcome the above-described shortcomings of prior art solutions would represent a welcome advancement of the art.

### SUMMARY

Many, if not all, of the above-described shortcomings of the prior art are overcome by a removable odometer for non-odometer equipped vehicles in accordance with the instant disclosure. In particular, such an odometer comprise a housing having a vehicle mounting device attached thereto. In an embodiment, the vehicle mounting device configured to be connectable to and removable from the non-odometer equipped vehicle. The housing further comprises a doppler radar module disposed in the housing. A processor is disposed in the housing and operatively connected to the doppler radar module and memory. In turn, the memory comprises executable instructions that, when executed by the processor, cause the processor to receive, from the doppler radar module, velocity-indicative data relative to a surface traveled by the non-odometer equipped vehicle. Thereafter, the processor operates to determine a distance traveled by the non-odometer equipped vehicle based on the velocity-indicative data.

In an embodiment, the processor operates to first convert the velocity-indicative data to velocity data and thereafter determine the distance traveled based on the velocity data.

Various implementations of the vehicle mounting device may be employed. Thus, in one embodiment, the vehicle mounting device comprises a magnet and, in another embodiment, the vehicle mounting device comprises a clamp. Regardless of its particular implementation, in another embodiment, the vehicle mounting device is configured for attachment to an underside structure of the non-odometer equipped vehicle. Further still, the vehicle mounting device may be configured relative to the housing such that the doppler radar module is oriented towards the surface traveled by the non-odometer equipped vehicle when the vehicle mounting device is connected to the non-odometer equipped vehicle.

The odometer may further comprise an amplifier having an amplifier input operatively connected to an output of the doppler radar module and an amplifier output operatively connected to an input of the processor. A data transfer port, mounted on, and accessible from an exterior of, the housing and operatively connected to the processor may also be provided. A wireless transceiver may be operatively connected to the processor. Furthermore, the odometer may comprise a display operatively connected to the processor and configured to display the distance traveled by the non-odometer equipped vehicle.

A corresponding method is also disclosed.

### BRIEF DESCRIPTION OF THE DRAWINGS

The foregoing and other features and advantages will be discussed in detail in the following non-limiting description of specific embodiments in connection with the accompanying drawings, in which:

FIG. 1 illustrates an example of a non-odometer equipped vehicle and various prior art odometers disposed thereon;

FIG. 2 illustrates a non-odometer equipped vehicle having disposed thereon a removable odometer in accordance with the instant disclosure;

FIG. 3 is a schematic block diagram of a removable odometer in accordance with the instant disclosure; and

FIG. 4 is a flowchart illustrating processing in accordance with the instant disclosure.

### DETAILED DESCRIPTION OF THE PRESENT EMBODIMENTS

As used herein, phrases substantially similar to “at least one of A, B or C” are intended to be interpreted in the disjunctive, i.e., to require A or B or C or any combination thereof unless stated or implied by context otherwise. Further, phrases substantially similar to “at least one of A, B and C” are intended to be interpreted in the conjunctive, i.e., to require at least one of A, at least one of B and at least one of C unless stated or implied by context otherwise. Further still, the term “substantially” or similar words requiring subjective comparison are intended to mean “within manufacturing tolerances” unless stated or implied by context otherwise.

As used herein, the phrase “operatively connected” refers to at least a functional relationship between two elements and may encompass configurations in which the two elements are directed connected to each other, i.e., without any intervening elements, or indirectly connected to each other, i.e., with intervening elements.

Referring now to FIG. 2, a non-odometer equipped vehicle 102 is shown having a removable odometer 200, in accordance with the instant disclosure, disposed thereon. In particular, the odometer 200 is connected to the vehicle 102 via a vehicle mounting device (not shown) that permits the odometer 200 to be connected to an underside surface 201 of the vehicle 102. For example, where the vehicle 102 comprises a semi-trailer as shown in the illustrated embodiment, the underside surface 201 could comprise an underside of a deck of the semi-trailer. As will be appreciated by those skilled in the art, the nature of the underside surface 201 will necessarily be dependent upon the nature of the vehicle, and that the instant disclosure is not limited in this regard. Furthermore, suitable mounting locations on the vehicle 102 are not necessarily restricted to only an underside surface 201. For example, the odometer 200 could be connected to the vehicle 102 on an rear vertical surface 203 thereof, or even a front or side surface of the vehicle 102. Regardless of the location chosen for connecting the odometer 200 to the vehicle 102, in an embodiment, the odometer 200 should be oriented such that a surface 208 upon which the vehicle 102 is traveling is consistently visible to a doppler radar module included in the odometer 200.

FIG. 2 illustrates the use of a doppler radar module (not shown in FIG. 2) by the odometer 200. In particular, as known in the art, a doppler radar module is capable of determining the velocity of an object (or providing data capable of being used to determine such velocity) based on measurements of so-called doppler shifts in transmitted electromagnetic signals.

An example of this is illustrated in FIG. 2 where a signal 204 (shown in solid lines) transmitted by the odometer 200 is directed to the surface 208 upon which the vehicle 102 is traveling. In the illustrated example, the transmitted signal 204 is directed toward the surface 208 at a non-zero angle (relative to a gravitational normal direction). The specific angle used for this purpose may be selected as a matter of design choice dependent upon, for example, the nature of the antennas (e.g., the field of view of such antennas) used by the doppler radar module. Doppler shifts in a frequency of the transmitted signal 204 result from movement of the vehicle (and, thus, the odometer 200) relative to the surface 208. For example, if the vehicle 102 is traveling from right to left as depicted in FIG. 2 and the transmitted signal 204 is angled downward from right to left as further shown, a reflection 206 (shown in dotted lines) of the transmitted signal 204 off of the surface 208 will tend to have a compressed wavelength (i.e., a higher frequency) as compared to the transmitted signal 204. On the other hand, if the vehicle 102 is traveling from left to right as depicted in FIG. 2 and the transmitted signal 204 continues to be angled downward from right to left, the reflection 206 of the transmitted signal 204 off of the surface 208 will tend to have an elongated wavelength (i.e., a lower frequency) as compared to the transmitted signal 204. These changes in frequency are dependent upon the velocity of the doppler radar module. By determining changes in frequency between the transmitted signal 204 and the reflected (received) signal 206, the doppler radar module is able to provide velocity-indicative data regarding the vehicle 102.

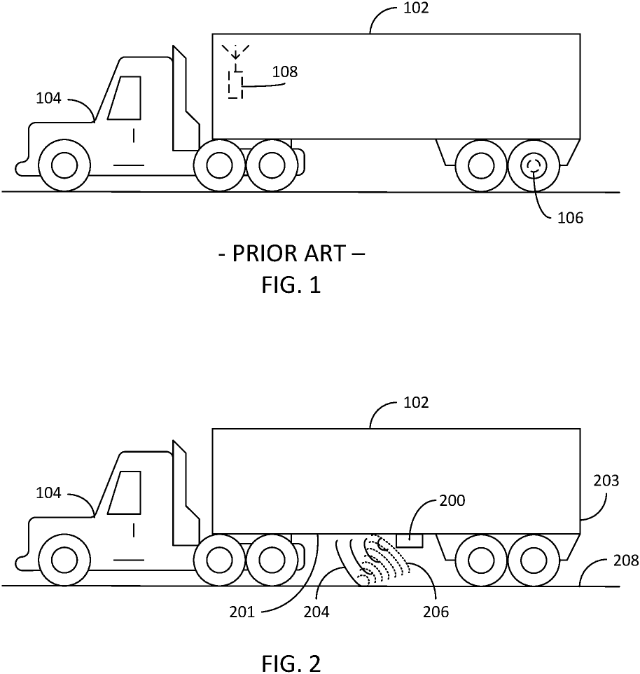

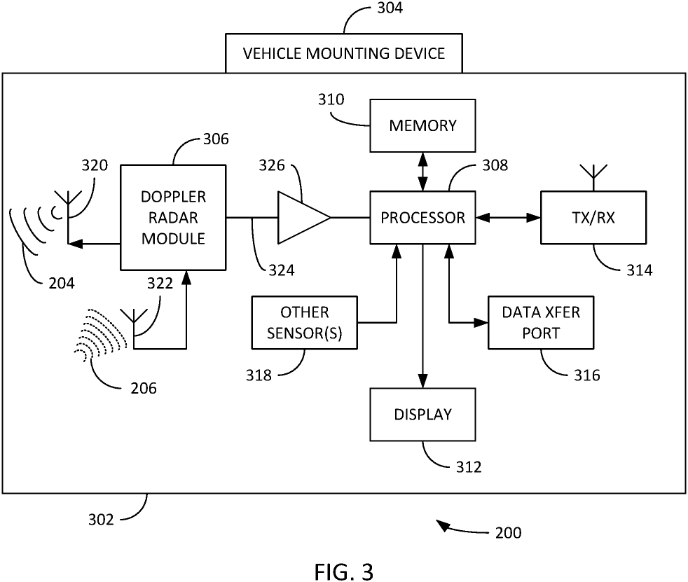

Referring now to FIG. 3, the odometer 200 of FIG. 1 is illustrated in greater detail in block form. In this embodiment, the odometer 200 comprises a housing 302 having vehicle mounting device 304 attached thereto. The housing 302, in addition to supporting the vehicle mounting device 304, is configured to support, and preferably substantially enclose, the various other components illustrated in FIG. 3 and described in further detail below. Thus, in an embodiment, the housing 302 is an enclosed compartment (with openings as described below) having dimensions sufficient to support/enclose all of the illustrated components and constructed of materials suitable for prolonged exposure to outside environmental conditions, such as a hard polymer material or corrosion-resistant metal.

The vehicle mounting device 304 comprises any suitable device that permits the odometer 200 to be readily connected to or disconnected from a vehicle, i.e., that permits the odometer 200 to be removable. For example, in an embodiment, the vehicle mounting device 304 comprises one or more magnets affixed to the housing 302 and having sufficient magnetic strength to reliably maintain the odometer 200 in connection with the vehicle throughout all reasonably conceivable usage conditions (e.g., moisture, heat, vibration, etc.). In an alternative embodiment, the vehicle mounting device 304 may comprise one or more clamps that can be tightened to, once again, securely connect the odometer 200 to the vehicle. Other suitable mechanism for implementing the vehicle mounting device, or combinations thereof, will be apparent to the skilled person (e.g., a flange having mounting holes in conjunction with suitable nuts and bolts to secure the flange to complementary mounting holes on the vehicle) and the instant disclosure is not limited in this regard.

As further shown in FIG. 3, the odometer 200 comprises a doppler radar module 306 operatively connected to a processor 308 that is, in turn, operatively connected to a memory 310 suitable for storage of executable instructions and data used by the processor 308 to carry out processing described herein. Thus, in an embodiment, the processor 308 may include one or more devices such as microprocessors, microcontrollers, digital signal processors, or combinations thereof, capable of executing stored instructions and operating upon stored data that is stored in, the memory 310. The memory 310 may include one or more devices such as volatile or nonvolatile memory including, but not limited to, random access memory (RAM) or read only memory (ROM). Furthermore, the memory 310 may be embodied in a variety of forms, such as a hard drive, optical disc drive, etc. Processor and memory arrangements of the types illustrated in FIG. 3 are well known to those having ordinary skill in the art and the instant disclosure is not limited in this regard.

The doppler radar module 306 comprises circuitry configured to operate one or more transmitting antennas 320 and one or more receiving antennas 322 so as to provide doppler-based velocity-indicative data 324 as described above. Commercially available modules for this purpose a readily available as known by the those skilled in the art. For example, such commercially available modules include modules typically designed for motion-detecting spotlight systems, which modules tend to be operable using low voltages. Once again, other commercially available modules suitable for the purposes described herein will be known to those skilled in the art. For example, doppler radar modules such as the HB100 Microwave Doppler Radar Detector Probe Wireless Sensor Module 10.525 GHz available from Shenzhen HiLetgo Technology Co., Ltd or the V-MD3 Radar transceiver available from RFbeam Microwave GmbH have been shown to provide acceptable performance in proof-of-concept testing. Generally, acceptable performance of the doppler radar module 306 will depend on the number of transmitting and receiving antennas needed to obtain reliable operation, which in turn affects the power requirements of the module 306.

As used herein velocity-indicative data 324 comprises any signal or digitally represented data that is either directly indicative of a measured velocity or that may be further processed to derive measured velocity. For example, in one embodiment, the velocity-indicative data 324 provided at an output of the doppler radar module 306 is a very low voltage signal comprising constructive/destructive interference waves provided by mixing the transmitted 204 and received 206 signals. In this case, the velocity-indicative data 324 may be amplified by a suitable amplifier circuit 326 with the resultant amplified signal then being provided to the processor 308. In other implementations, the output voltage of the doppler radar module 306 may be sufficiently large that the amplifier 326 is not necessary. In accordance with known techniques, the processor 308 (using any required analog-to-digital converters, if necessary; not shown) can then count wave peaks in the interference signal per unit of time as a measure of movement velocity.

Alternatively, the doppler radar module 306 may have sufficient processing capability on its own that it is capable of directly providing velocity data.

Regardless of the exact nature of the velocity-indicative data 324, the processor 308 can operate on the resulting velocity data to calculate distance traveled. That is, for a given velocity determination made over a specific period of time, the distance traveled during that period may be expressed as the product of the measured velocity (expressed, for example, in meters/second) with the period of time (expressed, in this case, in seconds). By continuously integrating such distances over a succession of velocity determinations, an overall distance traveled (such as might be provided by a conventional odometer) can be determined.

Additionally, though the instant disclosure is primarily focused on odometer operation and, consequently, obtaining distance traveled data, the processor 308 can be operated to obtain or determine additional data. For example, in addition to distance traveled (total, per trip), information such as vehicle speed (peak, average, trip profile) and time-stamped logging of such data may also be determined and stored by the processor 308.

As will be appreciated by those skilled in the art, the transmitting and receiving antennas 320, 322 are directional such that operation of the doppler radar module 306 is optimized when the transmitting and receiving antennas 320, 322 are positioned (when the odometer 200 is connected to the vehicle) such that they can “see” (i.e., are directed toward) the traveled surface at substantially all times. Given this, the configuration of the doppler radar module 306 and the corresponding antennas 320, 322 within the housing 302 will dictate the how the vehicle mounting device 304 is configured relative to the housing 302. That is, the vehicle mounting device 304 is preferably configured such that the odometer 200 can be connected to the vehicle such that the doppler radar module 306/antennas 320, 322 are necessarily oriented toward the surface traveled by the vehicle. For example, in the example illustrated in FIG. 3, where the transmitted and received signals 204, 206 are directed downward going from right to left by the corresponding transmitting and receiving antennas 320, 322, the vehicle mounting device 304 is attached to the top of the housing 302 such that the housing 302, and thus the antennas 320, 322, will be oriented as depicted in FIG. 3 when the odometer 200 is attached to an underside surface of the vehicle.

As further shown in FIG. 3, various other devices may be operatively coupled to the processor 308. For example, a suitable display 312, configured to display the distance traveled as calculated by the processor 308, may be provided. Alternatively, or additionally, the other types of data that may be collected and stored by the processor 308, as described above, may be provided to the display 312.

In another embodiment, a wireless transceiver 314 may be operatively connected to the microprocessor 308. The wireless transceiver 314 may be configured to operate according to any desired wireless communication protocol (e.g., mobile cellular radio, near-field communication (NFC), Bluetooth, etc.) such that the processor 308 is able to communicate any of its stored information to a suitably equipped external device. Furthermore, a data transfer port 316 may also be operatively connected to the processor 308. The port 316 may be configured to be accessible from the exterior of the housing 302 such that suitable device, e.g., a laptop computer, may be directedly coupled to the odometer 200. For example, the port 316 may comprise a Universal Serial Bus (USB) connector, as known in the art. Additionally, though not shown in FIG. 3, the odometer 200 may comprise a rechargeable battery or the like configured to provide power to all of the electrical components of the odometer 200. In this case, in addition to suitable recharging circuitry operatively connected to the battery, the port 316 may include wiring allowing an external power source (e.g., a battery charger) to be connected to the recharging circuitry via the port 316.

Finally, the odometer 200 may include one or more additional sensors 318 operatively connected to the processor 308. For example, this may include sensors for measuring temperature acceleration, vibration, gas species, etc. Such data provided by the additional sensor(s) 318 may be collected and made available by the processor 308 as described above.

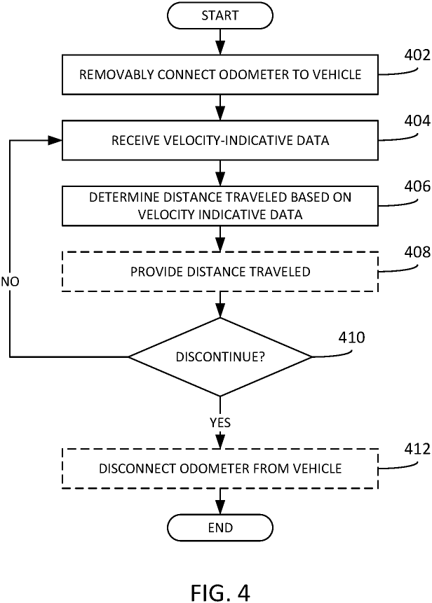

Referring now to FIG. 4, processing performed by an odometer in accordance with the instant disclosure is further described. For example, the processing illustrated in FIG. 4 (with the exception of block 402) may be implemented as stored instructions executed by a processor as described above relative to FIG. 3.

Beginning at block 402, the odometer is removably connected to the vehicle to be monitored. For example, a technician or mechanic can use the vehicle mounting device as described above to connect the odometer to the vehicle, bearing in mind the need to ensure proper orientation of the doppler radar transmit/receive antennas. Thereafter, at block 404, the odometer’s processor operates to continually receive velocity-indicative data from the doppler radar module. The received velocity-indicative data is then used, at block 406, to determine a distance traveled. Optionally, at block 408, the distance traveled data may be provided via a suitable device (e.g., display, wireless transceiver or data port) to a user or external device. Likewise, any of the other data collected and stored by the processor may also, or alternatively, be provided at block 408.

Thereafter, processing continues at block 410 where a determination is made whether to continue the processing of block 404-408. For example, the removal of power from the odometer or the selection of an on/off switch for the odometer may operate to provide the discontinue indication at block 410. Although block 410 is illustrated as occurring after blocks 404-408, in practice, those skilled in the art will appreciate that the determination whether to continue could be performed at substantially any time. Regardless, if the inquiry of block 410 is answered in the negative, then processing continues at block 404 where the receipt of velocity-indicative data continues. Alternatively, if the inquiry of block 410 is answered in the affirmative, the processing shown in FIG. 4 may terminate. Alternatively, an optional step may be performed at block 412, where the odometer is disconnected from the vehicle by a suitable technician or mechanic, for example.

An odometer according to the instant disclosure provides a number of advantages. By making the odometer capable of removable connection to the vehicle, otherwise non-odometer equipped vehicles may readily equipped for odometer-based monitoring. The removability of the odometer permits the device to be reused between a number of non-odometer equipped vehicles as desired. Furthermore, the odometer provides operational improvement over prior art solutions in that it directly measures movement across the surface traveled by the vehicle, thereby making it independent of tire conditions such as size, tread wear, alignment, etc., in the case of prior art hubodometers, and/or independent of GPS signal variations or power considerations, as in the case of prior art GPS trackers.

While the various embodiments in accordance with the instant disclosure have been described in conjunction with specific implementations thereof, it is evident that many alternatives, modifications and variations will be apparent to those skilled in the art. Accordingly, the preferred embodiments of the invention as set forth herein are intended to be illustrative only and not limiting so long as the variations thereof come within the scope of the appended claims and their equivalents.

What is claimed is:

1. A removable odometer for a non-odometer equipped vehicle, the odometer comprising:
a housing;
a vehicle mounting device attached to the housing, the vehicle mounting device configured to be connectable to and removable from the non-odometer equipped vehicle;
a doppler radar module disposed in the housing;
a processor disposed in the housing and operatively connected to the doppler radar module; and
memory, operatively connected to the processor and having executable instructions stored thereon that, when executed by the processor, cause the processor to:
receive, from the doppler radar module, velocity-indicative data relative to a surface traveled by the non-odometer equipped vehicle; and
determining a distance traveled by the non-odometer equipped vehicle based on the velocity-indicative data.

2. The odometer of claim 1, wherein the memory further comprises instructions that, when executed by the processor, cause the processor to:
convert the velocity-indicative data to velocity data; and
determine the distance traveled based on the velocity data.

3. The odometer of claim 1, wherein the vehicle mounting device comprises a magnet.

4. The odometer of claim 1, wherein the vehicle mounting device comprises a clamp.

5. The odometer of claim 1, wherein the vehicle mounting device is configured for attachment to an underside structure of the non-odometer equipped vehicle.

6. The odometer of claim 1, wherein the vehicle mounting device is configured relative to the housing such that the doppler radar module is oriented towards the surface traveled by the non-odometer equipped vehicle when the vehicle mounting device is connected to the non-odometer equipped vehicle.

7. The odometer of claim 1, further comprising:
an amplifier having an amplifier input operatively connected to an output of the doppler radar module and an amplifier output operatively connected to an input of the processor.

8. The odometer of claim 1, further comprising:
a data transfer port accessible from an exterior of the housing and operatively connected to the processor.

9. The odometer of claim 1, further comprising:
a wireless transceiver, operatively connected to the processor.

10. The odometer of claim 1, further comprising:
a display operatively connected to the processor and configured to display the distance traveled by the non-odometer equipped vehicle.
